(19) United States
(12) Patent Application Publication
(10) Pub. No.: US 2010/0192926 A1
(43) Pub. Date: Aug. 5, 2010

(54) GAS MIXER OF UNIVERSAL SMALL COMBUSTION-GAS ENGINE FOR AUTOMATICALLY CONTROLLING AMOUNT OF COMBUSTION GAS

(76) Inventors: Huachang Yang, Shanghai (CN); Hao Wu, Shanghai (CN)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/678,416

(22) PCT Filed: Mar. 2, 2009
(86) PCT No.: PCT/CN2009/000216

§ 371 Date: Mar. 16, 2010

(30) Foreign Application Priority Data
Mar. 6, 2008 (CN) 200820055971.6

(51) Int. Cl. F02M 21/04

(52) U.S. Cl. 123/527

(57) ABSTRACT

A gas mixer of universal small combustion-gas engine for automatically controlling amount of combustion gas is provided, which includes a casing, a choker, an air inlet, a combustion-gas passage, a main jet, a mixture outlet, a throttle valve, a passage, an additional combustion-gas passage and an gas automatically adjusting valve, the air inlet is provided on the upper end of a chamber of the casing, the chocker is provided under the air inlet, the combustion gas passage is provided on the side of the chamber of the casing, the main jet is provided on the front end of the combustion-gas passage and is connected with the chamber of the casing, the mixture outlet is provided on the lower end of the chamber of casing and the throttle valve is provided above the mixture outlet and under the combustion-gas passage, the additional combustion-gas passage is provided on rear end of the throttle valve, the passage is provided between the combustion-gas passage and the additional combustion-gas passage, the upper end of the passage is connected with the combustion-gas passage, the gas automatically adjusting valve is provided on the conjunction point between the passage and the additional combustion-gas passage, which is characterized in that the lower end of the shaft of the throttle valve is in the shape of furcation; the said automatically adjusting valve can be in the shape of round, oval or square. The advantages of this invention are reflected in the simplification of structure, the applicability and the fulfillment of automatically controlling of gas flow.

### TECHNICAL FIELD

A gas mixer of universal small combustion-gas engine for automatically controlling amount of combustion gas is provided in this invention, which is applicable in prime mover for electric generator, water pump, grass cutter, rotary culture machine and other equipment used for family, agriculture, industrial construction, non roadway vehicle, belonging to the technical domain of gas mixing device for automatically controlling amount of gas.

### TECHNICAL BACKGROUND

An outstanding predominance has been possessed by Chinese domestic machinery manufacturing industry and a wide international market for small universal gas engines has been provided since China enlisted under WTO.

The small universal gas engines burning gaseous fuel such as natural gas , LPG or methane and with the capacity less than 19 kW has been developing quickly, due to the common specialty in application of small universal gas engines, the gas mixer is almost solely used for air/gas mixing device, the gas mixer for small universal gas engine consists of a casing, a choker, an air inlet, a combustion-gas passage, a main jet, a gas mixer outlet, a throttle valve, a combustion-gas passage, an additional combustion-gas passage and an gas automatically adjusting valve; as shown in FIGS. 1 and 2, the lower end of throttle valve 11 is in the shape of a sector, the correct angel can hardly be maintained during machining, if it is failed to guarantee the correct angle, then the gas automatically adjusting valve cannot work well, while the entering air from air inlet 3 is mixed at the throat with the gas coming from the main jet, upstream the gas passage and eventually forming the combustion-gas. The performance of the gas mixer varies with the load of the engine and the concentration of the mixed combustion-gas should vary therewith, too, because the amount of the entering gas can not be controlled, thus the mixed gas can't fully meet the all load requirement of the engine, the mixed gas under insufficiently matching results in the improper work of engine, commonly the mixed gas with higher concentration than needed, causing an improper working condition of engine, such as hard ignition, fluctuation of rotary speed under idling or low load conditions, flareback at mixer and back fire in exhaust pipe.

### INVENTION CONTENT

This invention is to provide a gas mixer of universal small combustion-gas engine for automatically controlling amount of combustion gas. For fulfilling the above-mentioned purpose, the technical scheme of this invention is to provide a gas mixer of universal small combustion-gas engine for automatically controlling amount of combustion gas, which consists of a casing, a choker, an air inlet, a combustion-gas passage, a main jet, a mixer outlet, a throttle valve, a combustion-gas passage, an additional combustion-gas passage and a gas automatically adjusting valve, the air inlet is provided on the upper end of a chamber of the casing, the chocker is provided under the air inlet, the combustion-gas passage is provided on the side of the chamber of the casing, the main jet is provided on the front end of the combustion-gas passage and is connected with the chamber of the casing, the mixture outlet is provided on the lower end of the chamber of casing and the throttle valve is provided above the mixture outlet and under the combustion-gas passage, the additional combustion-gas passage is provided on rear end of the throttle valve, the passage is provided between the combustion-gas passage and the additional combustion-gas passage, the upper end of the passage is connected with the combustion-gas passage, the gas automatically adjusting valve is provided on the conjunction point between the passage and the additional combustion-gas passage, which is characterized in that the lower end of the shaft of the throttle valve is in the shape of furcation; the said automatically adjusting valve can be in the shape of round, oval or square.

The combustion-gas channel is divided into two passages, the main combustion-gas passage and the additional combustion-gas passage, those two passages converge at one channel in front of the outlet throat, there is a main jet in the main combustion-gas passage, and the additional combustion-gas adjusting aperture and the gas automatically adjusting valve are provided on the additional combustion-gas passage, the gas automatically adjusting valve is the key component, which links directly to the shaft of the throttle valve on the gas mixer and is integrated with the shaft, thus when the throttle valve is turning, the gas automatically adjusting valve is turning, too, therefore to vary the opening of the passage for combustion-gas passing through in the additional combustion-gas passage and the gas flow in the additional-gas passage is varied accordingly, in order to fulfill the target of automatically adjusting of the gas flow following the load of the engine, this invention can optimize the concentration of the mixed combustion-gas to fit all load conditions in the small universal gas engine, some abnormal phenomenon such as fluctuation of rotary speed, hard ignition, flareback at carburetor, back fire in exhaust pipe and unreachable the maximum load etc. will not occur.

The advantages of this invention are reflected in the simplification of structure, the applicability and the fulfillment of automatically controlling of gas flow.

### DESCRIPTION OF DRAWINGS ATTACHED

FIG. 1 is a sketch showing the original structure of throttle valve;

FIG. 2 is a sketch showing the gas mixer of universal small combustion-gas engine for automatically controlling amount of combustion gas

FIG. 3 is sketch showing the invented structure of throttle valve

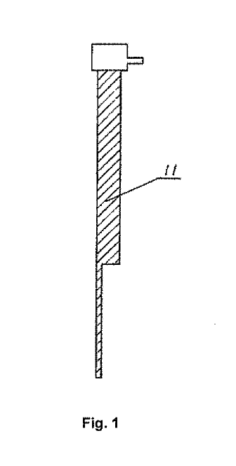

### EXAMPLE OF IMPLEMENTATION

A preferred embodiment of the invention is illustrated in the accompanying drawings in which:

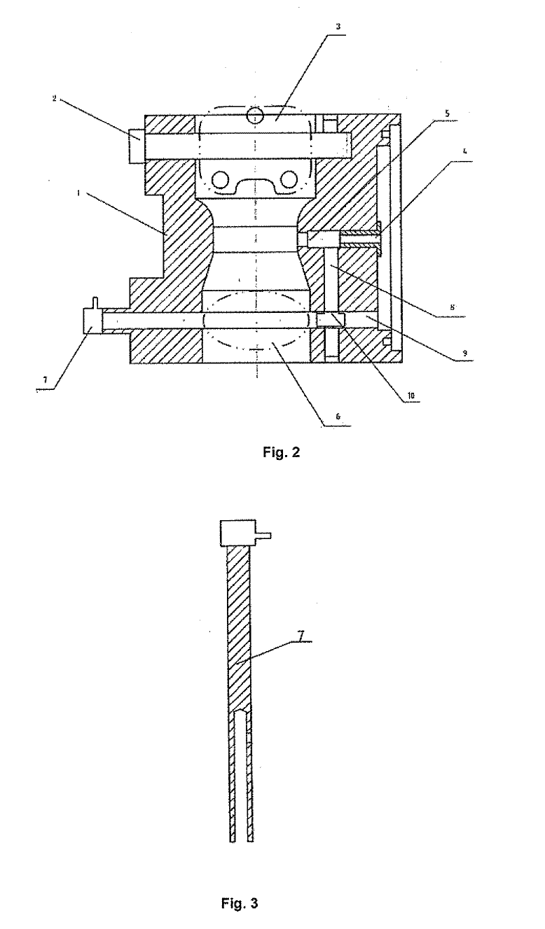

As shown in FIG. 2, it is gas mixer of universal small combustion-gas engine for automatically controlling amount of combustion gas, the said gas mixer consists of the casing 1, the choker 2, the air inlet 3, the combustion-gas passage 4, the main jet 5, the mixture outlet 6, the throttle valve 7, the passage 8, the additional combustion-gas passage 9 and the automatically adjusting valve 10.

The air inlet 3 is provided on the upper end of the chamber of casing 1, the choker 2 is provided under the air inlet 3, the combustion-gas passage 4 is provided on the side of the chamber of casing 1, the main jet 5 is provided on the front end of the combustion-gas passage 4 and is connected with the chamber of casing 1, the mixture outlet 6 is provided on the lower end of the chamber of casing 1 and the throttle valve 7 is provided above the mixture outlet 6 and under the combustion-gas passage 4, the additional combustion-gas passage 9 is provided on rear end of the throttle valve 7, the additional combustion-gas adjusting aperture is provided on the additional combustion-gas passage 9, the passage 8 is provided between the combustion-gas passage 4 and the additional combustion-gas passage 9, the upper end of the passage 8 is connected with the combustion-gas passage 4 and the lower end thereof is connected with the combustion-gas supplementary adjusting aperture of the additional combustion-gas passage 9, the gas automatically adjusting valve 10 is provided on the conjunction point between the passage 8 and the additional combustion-gas passage 9, the gas automatically adjusting valve 10 is integrated with shaft of the throttle valve 7, the turning of the shaft in the throttle valve 7 brings the turning of the gas automatically adjusting valve 10 as shown in FIG. 3, the lower end of the shaft of the throttle valve is in the shape of furcation; the said automatically adjusting valve can be in the shape of round, oval or square according to the output functions of different engines.

The combustion-gas flow entering the engine is a confluence of the combustion-gas from the passage 4 and the additional combustion-gas from passage 9, The combustion-gas from combustion-passage 4 is supplied to the engine at any operation condition, the combustion-gas flow depends on the opening of the main jet 5. The additional combustion-gas from the additional combustion-gas passage 9 depends on the additional combustion-gas adjusting aperture and the gas automatically adjusting valve 10, it can be selected for apertures of different shape and variable combination of two apertures to meet the different operation requirement, thus the turning of the gas automatically adjusting valve 10 can adjust the additional combustion-gas flow automatically, the main working principle is explained as follows:
1. When the engine is in idle condition, the opening of the throttling valve is in the minimum, the gas automatically adjusting valve is completely closed, just enough cutting off the additional combustion-gas passage and then no gas flows out from the additional combustion-gas passage.
2. When the engine is under the lower load, the opening of the throttling valve is small, the gas automatically adjusting partially is partially opened turning on the additional combustion-gas passage, there are only few gas flows out due to the small opening of the additional combustion-gas passage, and along with the load increases, the more widely opening of the throttling valve, and the gas automatically adjusting valve is also widely opened and turning on the additional combustion-gas passage accordingly and the gas flow from the additional combustion-gas passage increase, too.
3. When engine is under the full load, the throttling valve is in maximum opened position, the gas automatically adjusting valve is opened completely and turning on the additional combustion-gas passage most widely, the gas flow from the additional combustion-gas passage is at its maximum, because of the completely opening of the additional combustion-gas passage. The maximum combustion-gas flow depends on the additional combustion-gas adjusting aperture.

1. gas mixer of universal small combustion-gas engine for automatically controlling amount of combustion gas, which consists of the casing (1), the choker (2), the air inlet (3), the combustion-gas passage (4), the main jet (5), the mixture outlet (6), the throttling valve (7), the passage (8), the additional combustion-gas passage (9) and the gas automatically adjusting valve (10). The air inlet (3) is provided on the upper end of the chamber of casing (1), the choker (2) is provided under the air inlet (3), the combustion-gas passage (4) is provided on the side of the chamber of casing (1), the main jet (5) is provided on the front end of the combustion-gas passage (4) and is connected with the chamber of casing (1), the mixture outlet (6) is provided on the lower end of the chamber of casing (1) and the throttle valve (7) is provided above the mixture outlet (6) and under the combustion-gas passage (4), the additional combustion-gas passage (9) is provided on rear end of the throttle valve (7), the passage (8) is provided between the combustion-gas passage (4) and the additional combustion-gas passage (9), the upper end of the passage (8) is connected with the combustion-gas passage (4), the gas automatically adjusting valve (10) is provided on the conjunction point between the passage (8) and the additional combustion-gas passage (9), which is characterized in that the lower end of the shaft of the throttle valve (7) is in the shape of furcation; the said automatically adjusting valve (10) can be in the shape of round, oval or square.

2. According to the claim 1 the said gas mixer of universal small combustion-gas engine for automatically controlling amount of combustion gas is characterized in that the gas automatically adjusting valve (10) is integrated with the shaft (7) of the throttle valve (7).

3. According to the claim 1 the said gas mixer of universal small combustion-gas engine for automatically controlling amount of combustion gas is characterized in that the combustion-gas supplementary adjusting aperture is provided on the additional combustion-gas passage (9).
